(19) United States
(12) Patent Application Publication
(10) Pub. No.: US 2026/0019954 A1
(43) Pub. Date: Jan. 15, 2026

(54) ELECTRONIC DEVICE FOR ALLOCATING TRANSMIT POWER BASED ON HOUSING STATE

(71) Applicant: Samsung Electronics Co., Ltd., Suwon-si (KR)

(72) Inventors: Gangminh LEE, Suwon-si (KR); Dongwook LEE, Suwon-si (KR); Joohyun DO, Suwon-si (KR); Hyunseok YU, Suwon-si (KR); Jeongtaek LEE, Suwon-si (KR)

(73) Assignee: Samsung Electronics Co., Ltd., Suwon-si (KR)

(21) Appl. No.: 19/010,912

(22) Filed: Jan. 6, 2025

(30) Foreign Application Priority Data
Jul. 10, 2024 (KR) 10-2024-0091329

(51) Int. Cl. H04W 52/18

(52) U.S. Cl. CPC H04W 52/18

(57) ABSTRACT

An electronic device includes a first housing, a second housing connected to the first housing, a transmitter including a plurality of antennas respectively in the first housing or the second housing and the transmitter configured to control the plurality of antennas to transmit signals, and a communication processor configured to allocate transmit power of each of the plurality of antennas, the communication processor including a controller configured to calculate a consumed total exposure ratio (TER) value of each of the plurality of antennas based on a housing state between the first housing and the second housing and allocate transmit power to one or more transmit antennas from among the plurality of antennas based on the consumed TER value.

### CROSS-REFERENCE TO RELATED APPLICATION

This application is based on and claims priority under 35 U.S.C. § 119 to Korean Patent Application No. 10-2024-0091329, filed on Jul. 10, 2024, in the Korean Intellectual Property Office, the disclosure of which is incorporated by reference herein in its entirety.

### BACKGROUND

The inventive concepts relate to electronic devices for allocating transmit power based on a housing state.

Electronic devices may transmit radio-frequency (RF) signals through antennas to communicate with other devices. Electromagnetic waves due to RF signals transmitted through antennas may have a harmful influence on the human body. To reduce a harmful influence due to electromagnetic waves, public authorities have regulated total exposure ratio (TER) values that are measured when electronic devices transmit RF signals. Therefore, it is desirable for electronic devices to satisfy a TER value regulation condition when transmitting RF signals.

Here, one method for electronic devices to satisfy a TER value regulation condition, transmit power for RF signals of electronic devices may be reduced. Such a reduction in transmit power may cause a reduction in communication performance of electronic devices. Therefore, there is a desire to develop a method capable of satisfying a TER value regulation condition while minimizing or reducing a degradation in communication performance of an electronic device.

### SUMMARY

The inventive concepts provide electronic devices capable of providing optimum or desired communication performance while satisfying a total exposure ratio (TER) value regulation condition.

According to some aspects of the inventive concepts, there is provided an electronic device including a first housing, a second housing connected to the first housing, a transmitter including a plurality of antennas, the transmitter configured to control the plurality of antennas to transmit signals, the plurality of antennas being respectively in the first housing or the second housing, and a communication processor configured to allocate transmit power of each of the plurality of antennas, the communication processor including a controller configured to calculate a consumed total exposure ratio (TER) value of each of the plurality of antennas based on a housing state between the first housing and the second housing and allocate transmit power to one or more transmit antennas from among the plurality of antennas based on the consumed TER value.

According to some aspects of the inventive concepts, there is provided an operation method of an electronic device, the electronic device including a first housing, a second housing connected to the first housing, a transmitter including a plurality of antennas respectively in the first housing or the second housing and the transmitter configured to control the plurality of antennas to transmit signals, and a communication processor configured to allocate transmit power of each of the plurality of antennas, the operation method including calculating, via the communication processor, a consumed total exposure ratio (TER) value of each of the plurality of antennas based on a housing state between the first housing and the second housing and allocating, via the communication processor, transmit power to one or more transmit antennas from among the plurality of antennas based on the consumed TER value.

According to some aspects of the inventive concepts, there is provided an electronic device including a first housing, a second housing connected to the first housing, a transmitter including a plurality of antennas respectively in the first housing or the second housing and the transmitter configured to control the plurality of antennas to transmit signals, and a communication processor configured to allocate transmit power of each of the plurality of antennas, the communication processor including a controller configured to determine a device state based on a housing state between the first housing and the second housing at a consumption time point and at a current time point, calculate a consumed total exposure ratio (TER) value of each of the plurality of antennas based on the device state, and allocate transmit power to one or more transmit antennas from among the plurality of antennas based on the consumed TER value.

### BRIEF DESCRIPTION OF THE DRAWINGS

Embodiments will be more clearly understood from the following detailed description taken in conjunction with the accompanying drawings in which:

FIG. 1 is a diagram illustrating a wireless communication system including an electronic device, according to some example embodiments;

FIG. 2 is a diagram illustrating a total exposure ratio (TER) measurement interval of an electronic device, according to some example embodiments;

FIG. 3 is a diagram illustrating a structure of an electronic device, according to some example embodiments;

FIG. 4 is a block diagram illustrating an electronic device according to some example embodiments;

FIG. 5 is a block diagram illustrating an arrangement of a plurality of antennas that are included in an electronic device, according to some example embodiments;

FIG. 6 is a diagram illustrating an antenna index buffer, a used-power buffer, and a housing state buffer of an electronic device, according to some example embodiments;

FIG. 7 is a diagram illustrating an example of a method of calculating a window TER value when an electronic device is in a folded state, according to some example embodiments;

FIG. 8 is a diagram illustrating an example of a method of calculating a window TER value when an electronic device is changed from an open state to a folded state, according to some example embodiments;

FIG. 9 is a diagram illustrating an example of a method of calculating a window TER value when an electronic device is changed from a folded state to an open state, according to some example embodiments;

FIG. 10 is a flowchart illustrating an operation method of an electronic device, according to some example embodiments;

FIG. 11 is a flowchart illustrating a method of calculating a consumed TER value of an electronic device, according to some example embodiments;

FIG. 12 is a flowchart illustrating a method of determining a device state of an electronic device, according to some example embodiments;

FIG. 13 is a flowchart illustrating a method of allocating transmit power of an electronic device, according to some example embodiments; and

FIG. 14 is a block diagram illustrating user equipment according to some example embodiments.

### DETAILED DESCRIPTION

Hereinafter, example embodiments of the inventive concepts will be described in detail with reference to the accompanying drawings.

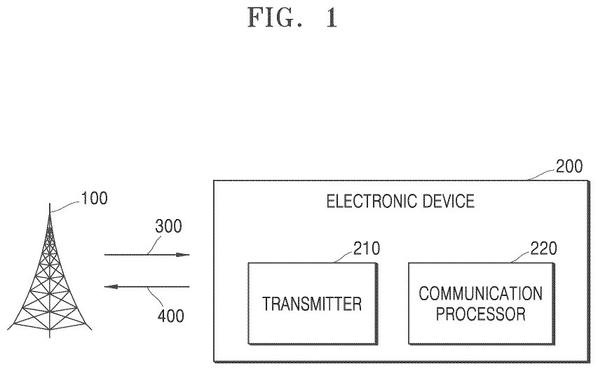

FIG. 1 is a diagram illustrating a wireless communication system including an electronic device, according to some example embodiments.

Referring to FIG. 1, the wireless communication system may include a base station 100 and an electronic device 200. The base station 100 and the electronic device 200 may communicate with each other via a downlink channel 300 and an uplink channel 400.

The base station 100 may generally refer to a fixed station communicating with the electronic device 200 and another base station and may exchange data and control information by communicating with the electronic device 200 and the other base station. The base station 100 may be referred to as a Node B, an evolved-Node B (eNB), a base transceiver system (BTS), an access point (AP), or the like.

The electronic device 200, which is a device capable of performing wireless communication, may be stationary or mobile and may include one of various devices capable of transmitting and receiving data and control information by communicating with the base station 100. The electronic device 200 may be referred to as terminal equipment, a mobile station (MS), a mobile terminal (MT), a user terminal (UT), a subscribe station (SS), a wireless device, a handheld device, or the like.

A wireless communication network between the base station 100 and the electronic device 200 may support a number of users (e.g., a large number of users) to communicate with each other by sharing available network resources. For example, in the wireless communication network, information may be transferred in various manners, such as code division multiple access (CDMA), frequency division multiple access (FDMA), orthogonal frequency division multiple access (OFDMA), single-carrier frequency division multiple access (SC-FDMA), and the like.

The electronic device 200 may include a transmitter 210 and a communication processor 220.

The transmitter 210 may transmit a radio-frequency (RF) signal to the base station 100 via the uplink channel 400. The transmitter 210 may receive an RF signal from the base station 100 via the downlink channel 300.

The transmitter 210 may include a plurality of antennas. The transmitter 210 may transmit and receive an RF signal by using at least one of the plurality of antennas. The transmitter 210 may output transmit power to at least one antenna to transmit an RF signal via the at least one antenna.

The communication processor 220 may allocate transmit power of each of the plurality of antennas of the transmitter 210. That is, the communication processor 220 may adjust the transmit power of each of the plurality of antennas and may cause an intended RF signal to be finally output via one or more antennas. In some example embodiments, the communication processor 220 may directly adjust the transmit power of each of the plurality of antennas, and in some example embodiments, the communication processor 220 may adjust the transmit power of each of the plurality of antennas via a separate power management integrated circuit (PMIC).

The communication processor 220 may be implemented by a processor, a neural processing unit (NPU), a graphics processing unit (GPU), or the like.

The communication processor 220 may set a transmit power limit of each of the plurality of antennas. The communication processor 220 may control each of the plurality of antennas to transmit an RF signal with transmit power that is not more than the transmit power limit.

The transmit power of each of the plurality of antennas may be adjusted by a downlink transmit power control (TPC) command that is transmitted from the base station 100 to the electronic device 200 via the downlink channel 300. For example, to maintain, at a target level, a signal-to-interference ratio (SIR) of an RF signal received from the electronic device 200, the base station 100 may transmit a TPC command to the electronic device 200 based on an estimated SIR. The electronic device 200 may adjust transmit power of RF signals transmitted to the base station 100 via the uplink channel 400, based on the TPC command received via the communication processor 220.

The transmit power of each of the plurality of antennas may be related to energy radiated from the electronic device 200. That is, strong electromagnetic waves may be generated by the electronic device 200 due to RF signals generated with higher transmit power, and the electromagnetic waves may have a harmful influence on a user. The harmful influence of such electromagnetic waves on the user may be measured through a specific absorption rate (SAR) value or a power density (PD) value. In addition, the SAR value or the PD value measured when an electronic device transmits an RF signal may be limited by a regulation condition for a total exposure ratio (TER) value, and the TER value regulation condition may be represented by Equation 1.

$$TER = {\sum }_{n = 0}^{N - 1} \frac{{SAR}_{avr , n}}{{SAR}_{limit}} + {\sum }_{m = 0}^{M - 1} \frac{{PD}_{avr , m}}{{PD}_{limit}} < 1 \qquad [ Equation 1 ]$$

In Equation 1, SARₗᵢₘᵢₜ may refer to a limit of an SAR value, which is determined by public authorities, SAR_{avr,n} may refer to an average value of SAR values in an n-th measurement interval, PDₗᵢₘᵢₜ may refer to a limit of a PD value, which is determined by the public authorities, and PD_{avr,m} may refer to an average value of PD values in an m-th measurement interval.

The SAR value and the PD value may each be calculated by a generally known mathematical expression. Here, the SAR value and the PD value may each be proportional to transmit power of the electronic device 200. Because the TER value is calculated as the sum of the SAR value and the PD value, the TER value may be proportional to the transmit power of the electronic device 200. Therefore, by increasing or decreasing the transmit power of the electronic device 200, the TER value measured when the electronic device 200 transmits an RF signal may be increased or decreased.

To satisfy the TER value regulation condition represented by Equation 1, when the electronic device 200 according to some example embodiments includes a first housing and a second housing, the communication processor 220 may calculate a consumed TER value of each of the plurality of antennas based on a housing state between the first housing and the second housing and may allocate transmit power to one or more transmit antennas from among the plurality of antennas based on the consumed TER value. By doing this, optimum or desired communication performance may be provided while the TER value regulation condition is satisfied.

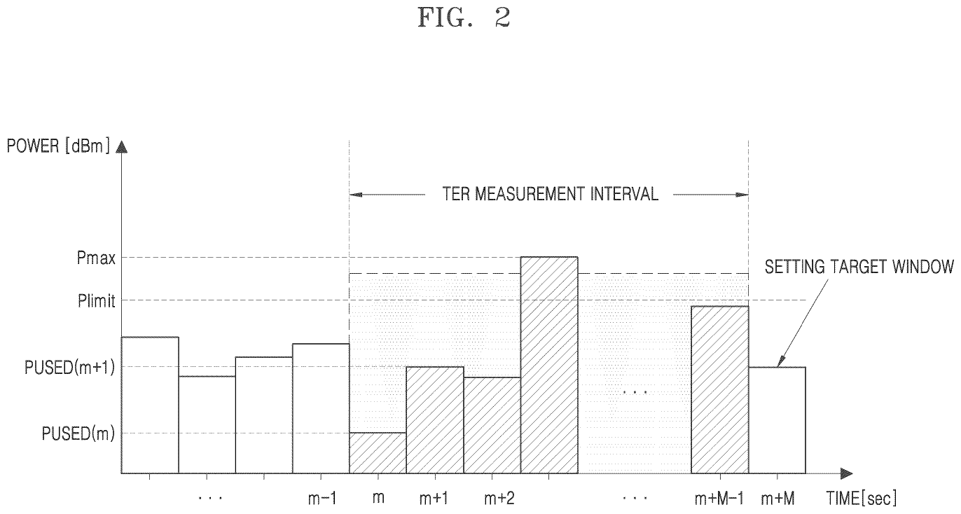

FIG. 2 is a diagram illustrating a TER measurement interval of an electronic device, according to some example embodiments.

Referring to FIG. 2, a graph of a histogram type, which illustrates a result of measuring used power over time, may be checked. In the graph of FIG. 2, the horizontal axis may represent time, the vertical axis may represent used power, and each interval may correspond to one window.

A window may be a unit having a preset (or, alternatively, desired or determined) length of time and, for example, one window may have a length of time of about or exactly 250 ms. One window may be divided into N slots. A slot may represent a time unit for transmitting a plurality of communication symbols. In some example embodiments, the communication processor 220 may measure transmit power of the transmitter 210 in units of slots and may obtain transmit power of a window unit by summing up transmit power measured for each slot.

The TER measurement interval may refer to an interval in which a TER value is measured for determining whether the TER value regulation condition is satisfied. In some example embodiments of FIG. 2, the TER measurement interval may include M windows (where M is an integer).

The TER measurement interval may be set based on a communication frequency band of the electronic device 200. For example, when the communication frequency band of the electronic device 200 is less than about or exactly 3 GHz, the TER measurement interval may be about or exactly 100 s and may include about or exactly 400 windows. In addition, when the communication frequency band of the electronic device 200 is at least about or exactly 3 GHz and less than about or exactly 6 GHz, the TER measurement interval may be about or exactly 60 s and may include about or exactly 240 windows. Furthermore, when the communication frequency band of the electronic device 200 is at least about or exactly 6 GHz, the TER measurement interval may be about or exactly 4 s and may include about or exactly 16 windows.

In some example embodiments, because the TER value is proportional to the transmit power of the electronic device 200, the electronic device 200 may calculate the TER value during the TER measurement interval based on used power during the TER measurement interval. In addition, the electronic device 200 may calculate a transmit power limit of a setting-target window based on the calculated TER value and may set transmit power of the setting-target window based on the transmit power limit of the setting-target window.

The setting-target window refers to a window for which transmit power is intended to be set based on the TER value of the TER measurement interval, and may be a window directly next to windows that are included in the TER measurement interval. In some example embodiments of FIG. 2, when the TER measurement interval includes a total of M windows from a time point t=m (where m is an integer) to a time point t=m+M−1, the setting-target window may be a window at a time point t=m+M.

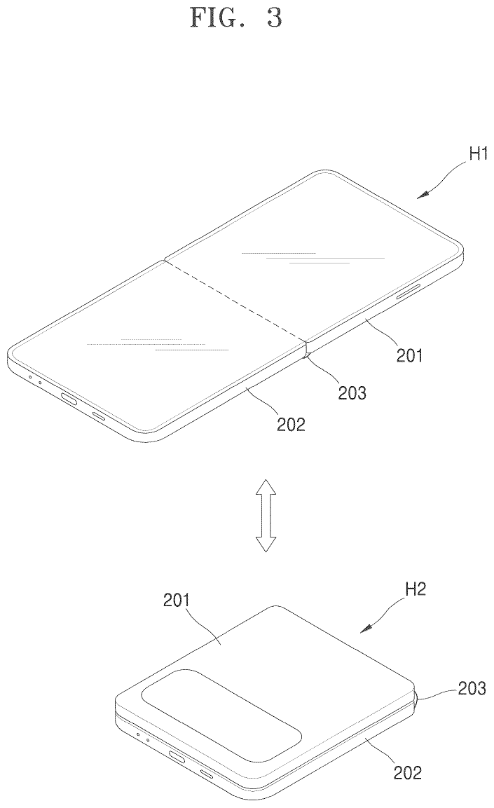

FIG. 3 is a diagram illustrating a structure of an electronic device, according to some example embodiments.

Referring to FIG. 3, the electronic device 200 according to some example embodiments may include a first housing 201, a second housing 202, and a hinge structure 203.

The first housing 201 and the second housing 202 may be connected to each other via the hinge structure 203. The first housing 201 and the second housing 202 may rotate about the hinge structure 203 and may have various housing states.

As shown at the top in FIG. 3, the electronic device 200 may have a state in which the first housing 201 and the second housing 202 are unfolded, and here, a housing state between the first housing 201 and the second housing 202 may be referred to as an open state (that is, H1). When the housing state between the first housing 201 and the second housing 202 is the open state, the angle between the first housing 201 and the second housing 202 may be about or exactly 180 degrees or an angle within a reference error from about or exactly 180 degrees.

On the other hand, as shown at the bottom in FIG. 3, the electronic device 200 may have a state in which the first housing 201 and the second housing 202 are folded, and here, the housing state between the first housing 201 and the second housing 202 may be referred to as a folded state (that is, H2). When the housing state between the first housing 201 and the second housing 202 is the folded state, the angle between the first housing 201 and the second housing 202 may be 0 degrees or an angle within a reference error from 0 degrees.

In some example embodiments, the housing state of the electronic device 200 may have the open state (that is, H1) or the folded state (that is, H2) and may freely switch to the open state (that is, H1) or the folded state (that is, H2). However, the above example embodiments are only illustrative, and other forms may be used, e.g., a device which can slide a housing from between an open state and a closed (folded) state, or fold along one or more axis, etc.

In some example embodiments, the electronic device 200 may calculate a consumed TER value of each of the plurality of antennas based on the housing state between the first housing 201 and the second housing 202 and may allocate transmit power to one or more transmit antennas from among the plurality of antennas based on the consumed TER value. By doing this, even when the housing state of the electronic device 200 switches, the TER value regulation condition may be satisfied.

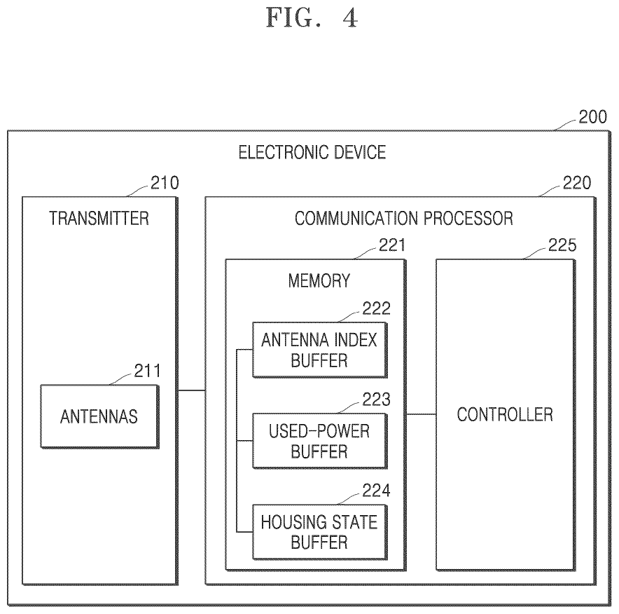

FIG. 4 is a block diagram illustrating an electronic device according to some example embodiments.

Referring to FIG. 4, the electronic device 200 according to some example embodiments may include the transmitter 210 and the communication processor 220.

The transmitter 210 may include a plurality of antennas 211. The transmitter 210 may transmit and receive an RF signal by using at least one antenna from among the plurality of antennas 211.

Each of the plurality of antennas 211 may transmit an RF signal to the base station 100 via the uplink channel 400. Each of the plurality of antennas 211 may receive an RF signal from the base station 100 via the downlink channel 300.

At least one antenna from among the plurality of antennas 211 may receive transmit power from the transmitter 210 and may transmit an RF signal by using the received transmit power.

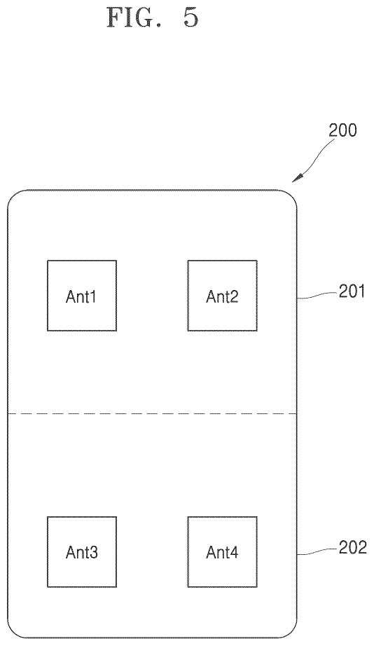

In some example embodiments, the plurality of antennas 211 may be arranged in the first housing 201 or the second housing 202. An example of an arrangement of the plurality of antennas 211 in the first housing 201 or the second housing 202 may be seen in FIG. 5.

FIG. 5 is a block diagram illustrating an arrangement of a plurality of antennas that are included in an electronic device, according to some example embodiments.

Referring to FIG. 5, an example of an arrangement of the plurality of antennas 211 that are included in the electronic device 200 according to some example embodiments may be confirmed. Although FIG. 5 illustrates some example embodiments in which the electronic device 200 includes a total of 4 antennas, the inventive concepts are not limited thereto, and the number and positions of the antennas 211 may be adjusted depending on embodiments.

In some example embodiments of FIG. 5, the plurality of antennas 211 may include first to fourth antennas Ant1 to Ant4. In some example embodiments of FIG. 5, the first antenna Ant1 and the second antenna Ant2 may be arranged in the first housing 201 of the electronic device 200. In some example embodiments of FIG. 5, the third antenna Ant3 and the fourth antenna Ant4 may be arranged in the second housing 202 of the electronic device 200.

Here, the TER value regulation condition, such as Equation 1, applies for each antenna. When it is determined with the first antenna Ant1 as a reference whether the TER value regulation condition is satisfied, the application of the TER value regulation condition or not may be determined by taking into account both a TER value due to exposure caused by the RF signal transmission of the first antenna Ant1 and the degree of influence exerted on the first antenna Ant1 by exposure caused by the RF signal transmission of the second to fourth antennas Ant2 to Ant4. Here, the degree of influence exerted on a j-th antenna Antj by exposure caused by the RF signal transmission of an i-th antenna Anti may be represented by a correlation coefficient, such as R(i, j), (where i and j are different natural numbers of 1 to 8). For example, the degree of influence exerted on the third antenna Ant3 by exposure caused by the RF signal transmission of the first antenna Ant1 may be represented by a correlation coefficient, such as R(1, 3).

Here, the degree of influence exerted on the third antenna Ant3 by exposure caused by the RF signal transmission of the first antenna Ant1 may be equal to the degree of influence exerted on the first antenna Ant1 by exposure caused by the RF signal transmission of the third antenna Ant3. That is, R(1, 3) may have a value that is equal to that of R(3, 1). Therefore, R(i, j) may be referred to as a correlation coefficient between the i-th antenna Anti and the j-th antenna Antj.

In some example embodiments, the housing state of the electronic device 200 may be the open state (that is, H1) or the folded state (that is, H2). Here, when the housing state of the electronic device 200 is the folded state (that is, H2), the first housing 201 and the second housing 202 overlap each other, and thus, the distance between each of the first antenna Ant1 and the second antenna Ant2 located in the first housing 201 and each of the third antenna Ant3 and the fourth antenna Ant4 located in the second housing 202 may be reduced as compared with the case where the housing state of the electronic device 200 is the open state (that is, H1). Therefore, a correlation coefficient between the first to fourth antennas Ant1 to Ant4.

Referring again to FIG. 4, the communication processor 220 may include a memory 221 and a controller 225.

In some example embodiments, the memory 221 may include an antenna index buffer 222, a used-power buffer 223, and a housing state buffer 224.

In some example embodiments, the antenna index buffer 222 may store used-antenna indices, which are indices of one or more used-antennas from among the plurality of antennas 211 respectively used in windows.

A used-antenna may refer to an antenna used for the transmission of an RF signal.

The communication processor 220 may store, in the antenna index buffer 222, a used-antenna index corresponding to each window.

In some example embodiments, the used-power buffer 223 may store used power of an antenna corresponding to the used-antenna index. The communication processor 220 may store, in the used-power buffer 223, the used power used by the antenna corresponding to the used-antenna index that is stored in the antenna index buffer 222.

In some example embodiments, the housing state buffer 224 may store a housing state at a time point corresponding to each window. That is, the housing state buffer 224 may store which state the housing state of the electronic device 200 has been in each window. The communication processor 220 may sense the housing state of the electronic device 200 via one or more sensors (not shown) and may store the housing state in the housing state buffer 224.

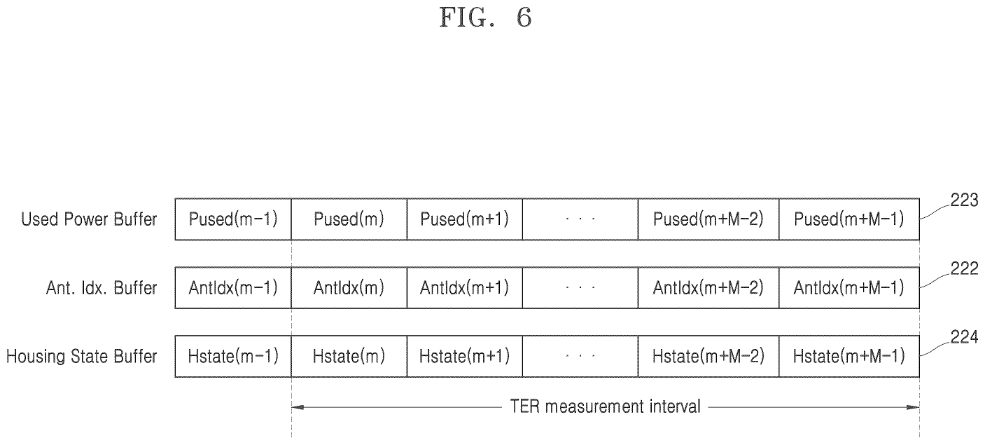

An example of each of the antenna index buffer 222, the used-power buffer 223, and the housing state buffer 224 may be seen in FIG. 6.

FIG. 6 is a diagram illustrating an antenna index buffer, a used-power buffer, and a housing state buffer of an electronic device, according to some example embodiments.

Referring to FIG. 6, the used-power buffer 223 is shown at the top, the antenna index buffer 222 is shown in the middle, and the housing state buffer 224 is shown at the bottom.

In each region of the antenna index buffer 222, a used-antenna index of a window corresponding thereto may be stored. For example, a used-antenna index of a window corresponding to a time point t=m may be stored in a region indicated by AntIdx(m), and a used-antenna index of a window corresponding to a time point t=m+M−1 may be stored in a region indicated by AntIdx(m+M−1).

When there are a plurality of used-antennas in a window at a particular time point, a plurality of used-antenna indices may be respectively stored in a plurality of antenna index buffers.

In each region of the used-power buffer 223, the used power of a used-antenna in a window corresponding thereto may be stored. For example, the used power of a used-antenna of the window corresponding to the time point t=m may be stored in a region indicated by Pused(m), and the used power of a used-antenna of the window corresponding to the time point t=m+M−1 may be stored in a region indicated by Pused(m+M−1).

Here, the used power stored in each region of the used-power buffer 223 may correspond to the used-antenna index stored in each region of the antenna index buffer 222. For example, the used power of a used-antenna corresponding to the used-antenna index stored in the region AntIdx(m) of the antenna index buffer 222 may be stored in the region Pused(m) of the used-power buffer 223.

When there are a plurality of used-antennas in a window at a particular time point, pieces of used power of the plurality of used-antennas may be respectively stored in a plurality of used-power buffers.

In each region of the housing state buffer 224, a housing state of a window corresponding thereto may be stored. For example, a housing state of the window corresponding to the time point t=m may be stored in a region indicated by Hstate(m), and a housing state of the window corresponding to the time point t=m+M−1 may be stored in a region indicated by Hstate(m+M−1).

Referring again to FIG. 3, the controller 225 may control all operations of the communication processor 220.

In some example embodiments, the controller 225 may calculate a consumed TER value of each of the plurality of antennas 211 based on the housing state between the first housing 201 and the second housing 202 and may allocate transmit power to one or more transmit antennas from among the plurality of antennas 211 based on the consumed TER value.

More specifically, in some example embodiments, the controller 225 may determine a device state based on a housing state at a consumption time point and a housing state at a current time point.

The current time point may be the latest time point within the TER measurement interval. When the TER measurement interval is the same as shown in FIG. 2, the current time point may be a time point t=m+M−1.

The consumption time point may be a time point corresponding to a particular window, when a TER value consumed in the particular window within the TER measurement interval is calculated. In the case where the TER measurement interval is the same as shown in FIG. 2, when a TER value consumed in a window including a time point t=m+2 is calculated, the consumption time point may be a time point t=m+2. When the TER measurement interval is the same as shown in FIG. 2, the consumption time point may be one time point from among the time point t=m to the time point t=m+M−1.

In some example embodiments, the controller 225 may read a housing state at the consumption time point from the housing state buffer 224. In addition, in some example embodiments, the controller 225 may read a housing state at the current time point from the housing state buffer 224.

The device state may indicate whether there is a change in the housing state at each of the consumption time point and the current time point.

In some example embodiments, when the housing state at the consumption time point is the folded state (that is, H2), the controller 225 may determine the device state to be a first state. Here, the first state may indicate that the housing state at the consumption time point has been the folded state regardless of the housing state at the current time point.

In some example embodiments, when the housing state at the consumption time point is the open state and the housing state at the current time point is the open state, the controller 225 may determine the device state to be a second state. Here, the second state may indicate that the electronic device 200 is maintained in the open state at the consumption time point and the current time point.

In some example embodiments, when the housing state at the consumption time point is the open state and the housing state at the current time point is the folded state, the controller 225 may determine the device state to be a third state. Here, the third state may indicate that the electronic device 200 having been in the open state at the consumption time point is changed to the folded state at the current time point.

In some example embodiments, the controller 225 may calculate a window TER value at the consumption time point based on the device state. The window TER value may represent a TER value used in one window from among a plurality of windows that are included in the TER measurement interval. The controller 225 may calculate the window TER value by using a different method depending on the device state.

In some example embodiments, when the device state is the first state, the controller 225 may calculate the window TER value at the consumption time point by adding up respective TER values of the plurality of antennas 211 at the consumption time point. Here, the controller 225 may calculate the window TER value at the consumption time point by using Equation 2 shown below.

$${TER}_{s 1} ( m - j , k ) = {\sum }_{i = 1}^{N} {TER}_{i} ( m - j ) \qquad [ Equation 2 ]$$

In Equation 2, m may be the current time point, j may be a difference between the current time point and the consumption time point, m−j may be the consumption time point, k may be an index of an antenna that is a reference for measuring a window TER value, and N may be the number of antennas 211. Here, TERₛ₁(m−j, k) may represent a window TER value with a k-th antenna (where k is an integer of 1 to N) as a reference at the consumption time point when the device state is the first state, and TERᵢ(m−j) may represent a window TER value of an i-th antenna at the consumption time point.

Here, the controller 225 may read a used-antenna index from the antenna index buffer 222, may read used power of an antenna corresponding to the used-antenna index from the used-power buffer 223, and may calculate TERᵢ(m−j) that is a window TER value, based on the used-antenna index and the used power.

That is, when the device state is the first state and thus indicates that the housing state at the consumption time point is the folded state, the window TER value at the consumption time point may be calculated by adding up TER values respectively used at the consumption time point by the plurality of antennas 211 as shown in Equation 2. This may mean that, when the device state at the consumption time point is the folded state, the window TER value at the consumption time point is calculated by taking into account that a correlation between the plurality of antennas 211 increases along with the decreasing distance between the plurality of antennas 211, that is, this calculation may be performed under the assumption that the correlation between the plurality of antennas 211 is 1.

In some example embodiments, when the device state is the second state, the controller 225 may calculate the window TER value at the consumption time point based on the respective TER values of the plurality of antennas 211 at the consumption time point and a correlation coefficient between the plurality of antennas 211. Here, the controller 225 may calculate the window TER value at the consumption time point by using Equation 3 shown below.

$${TER}_{s 2} ( m - j , k ) = {\sum }_{i = 1}^{N} R ( k , i ) \times {TER}_{i} ( m - j ) \qquad [ Equation 3 ]$$

In Equation 3, R(k, i) may be a correlation coefficient between a k-th antenna Antk and an i-th antenna Anti. Here, TERₛ₂(m−j, k) may represent a window TER value with the k-th antenna as a reference at the consumption time point when the device state is the second state.

That is, when the device state is the second state and thus indicates that the housing state continues to be the open state at the consumption time point and the current time point, the window TER value at the consumption time point may be calculated by adding up values that are obtained by respectively multiplying TER values, which are respectively used at the consumption time point by the plurality of antennas 211, by correlation coefficients between each of the plurality of antennas and a reference antenna (the k-th antenna in Equation 3), as shown in Equation 3.

In some example embodiments, when the device state is the third state, the controller 225 may calculate the window TER value at the consumption time point by selecting the maximum value from among a window TER value in the case where the device state is the second state and the respective TER values of the plurality of antennas 211 at the consumption time point. Here, the controller 225 may calculate the window TER value at the consumption time point by using Equation 4 shown below.

$${TER}_{s 3} ( m - j , k ) = max ( {TER}_{s 2} ( m - j , k ) , \\ {TER}_{1} ( m - j ) , {TER}_{2} ( m - j ) , ... , {TER}_{N} ( m - j ) ) \qquad [ Equation 4 ]$$

That is, when the device state is the third state and thus indicates that the electronic device 200 having been in the open state at the consumption time point is changed to the folded state at the current time point, the window TER value at the consumption time point may be calculated by selecting the maximum value from among the window TER value at the consumption time point calculated under the assumption that the device state is the second state and the TER values respectively used at the consumption time point by the plurality of antennas 211, as shown in Equation 4. This may be for (for example, maximally or conservatively) taking into account a window TER value to prevent or reduce a situation where the TER value regulation condition is not temporarily satisfied due to an instantaneous increase in the correlation coefficient between the plurality of antennas 211 as the electronic device 200 is currently in the folded state.

In some example embodiments, the controller 225 may calculate a consumed TER value based on window TER values at time points that are included in the TER measurement interval. The consumed TER value may represent a TER value used during the TER measurement interval. Here, the controller 225 may calculate the consumed TER value by using Equations 5 to 8 shown below.

$${TER}_{Used} = {\sum }_{j = 1}^{M} ( {TER}_{s 1} ( m - j , k ) \times {flag}_{s 1} ( m , j ) + {TER}_{s 2} ( m - j , k ) \times {flag}_{s 2} ( m , j ) + {TER}_{s 3} ( m - j , k ) \times {flag}_{s 3} ( m , j ) ) \qquad [ Equation 5 ]$$

$${flag}_{s 1} ( m , j ) = \{ \begin{matrix}1 , & if folded state at t = m - j \\ 0 , & else\end{matrix} \qquad [ Equation 6 ]$$

$${flag}_{s 2} ( m , j ) = \{ \begin{matrix}1 , & if open state at t = m - j and t = m \\ 0 , & else\end{matrix} \qquad [ Equation 7 ]$$

$${flag}_{s 3} ( m , j ) = \{ \begin{matrix}1 , & if open state at t = m - j and folded state at t = m \\ 0 , & else\end{matrix} \qquad [ Equation 8 ]$$

In Equations 5 to 8, TER_{Used} may be a consumed TER value, M is the total number of windows that are included in the TER measurement interval, flagₛ₁(m, j) may be a value indicating whether the device state at the consumption time point is the first state, flagₛ₂(m, j) may be a value indicating whether the device state at the consumption time point is the second state, and flagₛ₃(m, j) may be a value indicating whether the device state at the consumption time point is the third state.

R(k, i) may be a correlation coefficient between the k-th antenna Antk and the i-th antenna Anti. Here, TERₛ₂(m−j, k) may represent a window TER value with the k-th antenna as a reference at the consumption time point when the device state is the second state.

In some example embodiments, the controller 225 may allocate transmit power to one or more transmit antennas from among the plurality of antennas 211 based on the consumed TER value. The one or more transmit antennas are antennas that may be controlled to transmit RF signals in the setting-target window, and indices of the one or more transmit antennas may be stored as used-antenna indices in the antenna index buffer 222.

In some example embodiments, the controller 225 may calculate a residual TER value based on the consumed TER value and a limit TER value. The limit TER value may represent a TER value that may be used during the TER measurement interval. The residual TER value may be a value indicating how less a TER value has been used with respect to the limit TER value during the TER measurement interval. The controller 225 may calculate the residual TER value by subtracting the consumed TER value from the limit TER value.

In some example embodiments, the controller 225 may allocate transmit power to one or more transmit antennas based on the residual TER value. The controller 225 may calculate an available TER value based on the residual TER value, the available TER value being a limit of a TER value capable of being used in the setting-target window. The controller 225 may calculate a transmit power limit of a used-antenna based on the available TER value. The controller 225 may allocate transmit power to one or more transmit antennas based on the transmit power limit. For example, according to some example embodiments, there may be an increase in device longevity and/or power efficiency of the device based on the above methods. Therefore, the improved devices and methods overcome the deficiencies of the conventional devices and methods while reducing resource consumption and RF emissions, and/or improving device longevity and/or power efficiency. Further, there is an improvement in user experience in the device by providing the improved process.

As described above, use of the electronic device 200 according to the inventive concepts may allow optimum or desired communication performance to be provided while the TER value regulation condition is satisfied, by allocating transmit power to one or more transmit antennas from among a plurality of antennas based on the housing state between the first housing 201 and the second housing 202.

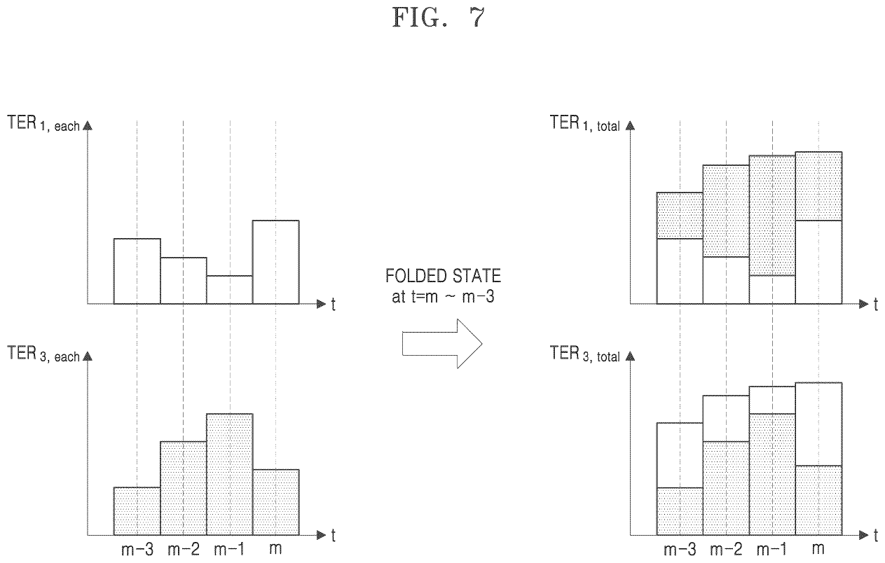

FIG. 7 is a diagram illustrating an example of a method of calculating a window TER value when an electronic device is in a folded state, according to some example embodiments.

Referring to FIG. 7, it may be confirmed that, when RF signals are transmitted via the first antenna Ant1 and the third antenna Ant3, TER_{1,each} corresponding to a window TER value used by the first antenna Ant1 is illustrated over time in the graph on the top left, TER_{3,each} corresponding to a window TER value used by the third antenna Ant3 is illustrated over time in the graph on the bottom left, TER_{1,total} corresponding to a window TER value measured with the first antenna Ant1 as a reference is illustrated over time in the graph on the top right, and TER_{3,total} corresponding to a window TER value measured with the third antenna Ant3 as a reference is illustrated over time in the graph on the bottom left. Here, in some example embodiments of FIG. 7, the TER measurement interval may range from a time point t=m−3 to a time point t=m, and the housing state may continue to be the folded state from the time point t=m−3 until the time point t=m.

A window TER value at the time point t=m−3 may be calculated as follows. At t=m−3 that is the consumption time point, because the housing state is the folded state, the device state may be the first state. When the device state is the first state, a window TER value at the consumption time point may be calculated by adding up the respective TER values of the plurality of antennas 211 at the consumption time point. Therefore, TER_{1,total}(m−3)=TER_{3,total}(m−3)=TER_{1,each}(m−3)+TER_{3,each}(m−3) may be satisfied.

A window TER value at the time point t=m−2 may be calculated as follows. At t=m−2 that is the consumption time point, because the housing state is the folded state, the device state may be the first state. Because the device state is the first state, TER_{1,total}(m−2)=TER_{3,total}(m−2)=TER_{1,each}(m−2)+TER_{3,each}(m−2) may be satisfied in the same manner as at the time point t=m−3.

A window TER value at the time point t=m−1 may be calculated as follows. At t=m−1 that is the consumption time point, because the housing state is the folded state, the device state may be the first state. Because the device state is the first state, TER_{1,total}(m−1)=TER_{3,total}(m−1)=TER_{1,each}(m−1)+TER_{3,each}(m−1) may be satisfied in the same manner as at the time point t=m−3.

A window TER value at the time point t=m may be calculated as follows. At t=m that is the consumption time point, because the housing state is the folded state, the device state may be the first state. Because the device state is the first state, TER_{1,total}(m)=TER_{3,total}(m)=TER_{1,each}(m)+TER_{3,each}(m) may be satisfied in the same manner as at the time point t=m−3.

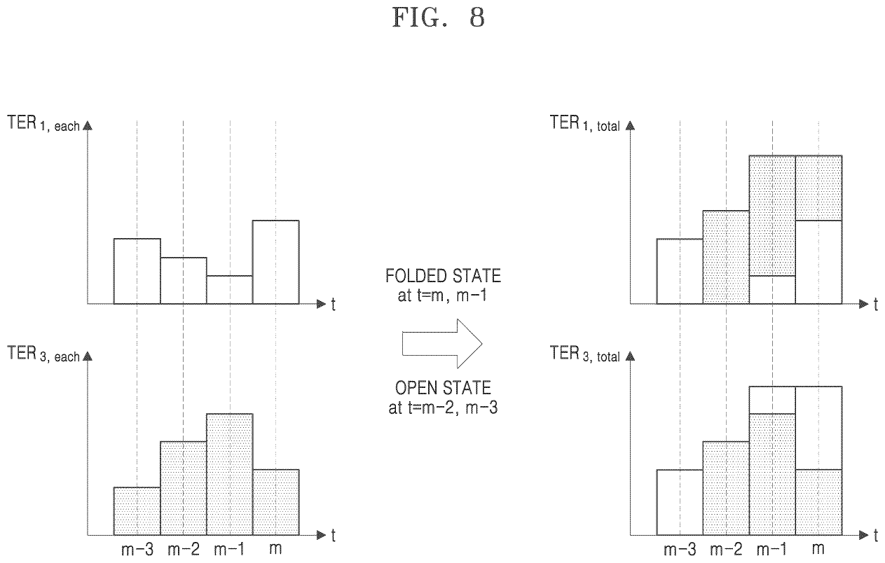

FIG. 8 is a diagram illustrating an example of a method of calculating a window TER value when an electronic device is changed from an open state to a folded state, according to some example embodiments.

Referring to FIG. 8, unlike some example embodiments of FIG. 7, some example embodiments, in which the housing state is the open state from the time point t=m−3 until the time point t=m−2 and is the folded state from the time point t=m−1 until the time point t=m, may be confirmed. Here, the correlation coefficient between the first antenna Ant1 and the third antenna Ant3 is assumed to be 0.

A window TER value at the time point t=m−3 may be calculated as follows. Because the housing state is the open state at t=m−3 that is the consumption time point and the housing state is the folded state at t=m that is the current time point, the device state may be the third state. When the device state is the third state, the window TER value at the consumption time point may be calculated by selecting the maximum value from among a window TER value in the case where the device state is the second state and the respective TER values of the plurality of antennas 211. Here, because TER_{1,each}(m−3)>TER_{3,each}(m−3) and the correlation coefficient between the first antenna Ant1 and the third antenna Ant3 is 0, the window TER value in the case where the device state is the second state is TER_{1,each}(m−3) or TER_{3,each}(m−3), and thus, TER_{1,total}(m−3)=TER_{3,tota1}(m−3)=TER_{1,each}(m−3) may be satisfied.

A window TER value at the time point t=m−2 may be calculated as follows. Because the housing state is the open state at t=m−2 that is the consumption time point and the housing state is the folded state at t=m that is the current time point, the device state may be the third state. Because the device state is the third state, TER_{1,each}(m−3)<TER_{3,each}(m−3), and thus, TER_{1,total}(m−2)=TER_{3,total}(m−2)=TER_{3,each}(m−2) may be satisfied, in the same manner as at the time point t=m−3.

A window TER value at the time point t=m−1 may be calculated as follows. At t=m−1 that is the consumption time point, because the housing state is the folded state, the device state is the first state. When the device state is the first state, the window TER value at the consumption time point may be calculated by adding up the respective TER values of the plurality of antennas 211 at the consumption time point. Therefore, TER_{1,total}(m−1)=TER_{3,total}(m−1)=TER_{1,each}(m−1)+TER_{3,each}(m−1) may be satisfied.

A window TER value at the time point t=m may be calculated as follows. At t=m that is the consumption time point, because the housing state is the folded state, the device state may be the first state. Because the device state is the first state, TER_{1,total}(m)=TER_{3,total}(m)=TER_{1,each}(m)+TER_{3,each}(m) may be satisfied in the same manner as at the time point t=m−1.

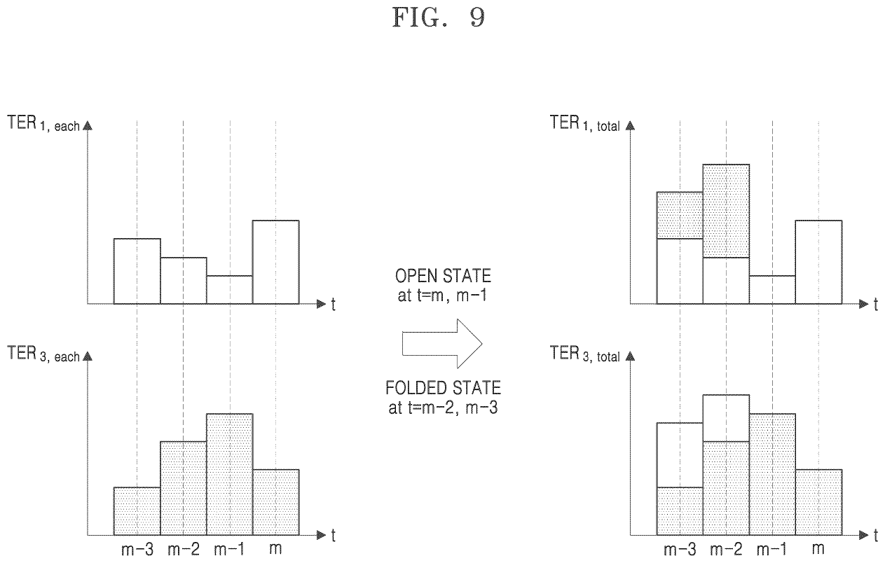

FIG. 9 is a diagram illustrating an example of a method of calculating a window TER value when an electronic device is changed from a folded state to an open state, according to some example embodiments.

Referring to FIG. 9, unlike some example embodiments of FIGS. 7 and 8, some example embodiments, in which the housing state is the folded state from the time point t=m−3 until the time point t=m−2 and is the open state from the time point t=m−1 until the time point t=m, may be confirmed. Here, the correlation coefficient between the first antenna Ant1 and the third antenna Ant3 is assumed to be 0.

A window TER value at the time point t=m−3 may be calculated as follows. At t=m−3 that is the consumption time point, because the housing state is the folded state, the device state may be the first state. When the device state is the first state, the window TER value at the consumption time point may be calculated by adding up the respective TER values of the plurality of antennas 211 at the consumption time point. Therefore, TER_{1,total}(m−3)=TER_{3,total}(m−3)=TER_{1,each}(m−3)+TER_{3,each}(m−3) may be satisfied.

A window TER value at the time point t=m−2 may be calculated as follows. At t=m−2 that is the consumption time point, because the housing state is the folded state, the device state may be the first state. Because the device state is the first state, TER_{1,total}(m−2)=TER_{3,total}(m−2)=TER_{1,each}(m−2)+TER_{3,each}(m−2) may be satisfied in the same manner as at the time point t=m−3.

A window TER value at the time point t=m−1 may be calculated as follows. Because the housing state is the open state at t=m−1 that is the consumption time point and the housing state is the open state at t=m that is the current time point, the device state may be the second state. When the device state is the second state, the window TER value at the consumption time point may be calculated based on the respective TER values of the plurality of antennas 211 and the correlation coefficient between the plurality of antennas 211. Here, because the correlation coefficient between the first antenna Ant1 and the third antenna Ant3 is 0, TER_{1,total}(m−1)=TER_{1,each}(m−1) and TER_{3,total}(m−1)=TER_{3,each}(m−1) may be satisfied.

A window TER value at the time point t=m may be calculated as follows. Because the housing state is the open state at t=m that is the consumption time point and the housing state is the open state at t=m that is the current time point, the device state may be the second state. The device state is the second state, and thus, in the same manner as at the time point t=m−1, because the correlation coefficient between the first antenna Ant1 and the third antenna Ant3 is 0, TER_{1,total}(m)=TER_{1,each}(m) and TER_{3,total}(m)=TER_{3,each}(m) may be satisfied.

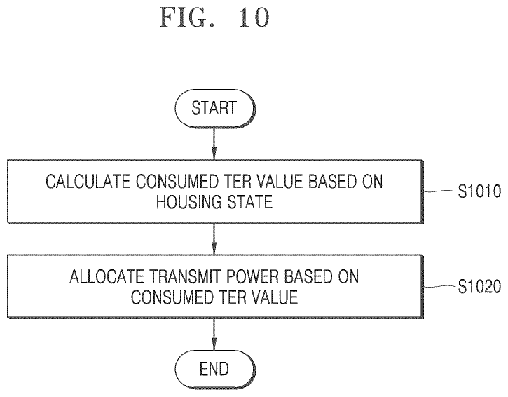

FIG. 10 is a flowchart illustrating an operation method of an electronic device, according to some example embodiments.

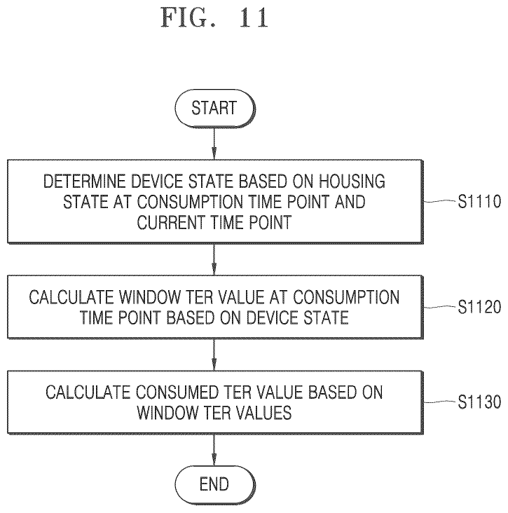

Referring to FIG. 10, in operation S1010, the electronic device 200 may calculate a consumed TER value via the communication processor 220, based on the housing state. A more detailed method of calculating the consumed TER value based on the housing state may be the same as shown in FIG. 11.

FIG. 11 is a flowchart illustrating a method of calculating a consumed TER value of an electronic device, according to some example embodiments.

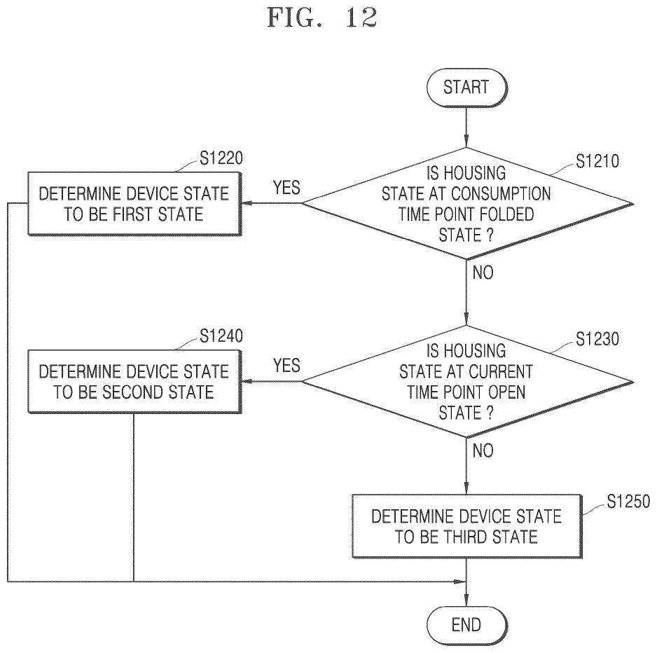

Referring to FIG. 11, in operation S1110, the electronic device 200 may determine the device state via the communication processor 220, based on the housing state at the consumption time point and the housing state at the current time point. The controller 225 of the communication processor 220 may read the housing state at the consumption time point from the housing state buffer 224. In addition, the communication processor 220 may read the housing state at the current time point from the housing state buffer 224. The communication processor 220 may determine a device state based on the housing state at the consumption time point and the housing state at the current time point, which are read from the housing state buffer 224. A more detailed method of determining the device state may be the same as shown in FIG. 12.

FIG. 12 is a flowchart illustrating a method of determining a device state of an electronic device, according to some example embodiments.

Referring to FIG. 12, in operation S1210, the communication processor 220 may determine whether the housing state at the consumption time point is the folded state.

When the housing state at the consumption time point, which is read from the housing state buffer 224, is the folded state, the method may proceed to operation S1220, and the communication processor 220 may determine the device state to be the first state.

When the housing state at the consumption time point, which is read from the housing state buffer 224, is not the folded state but the open state, the method may proceed to operation S1230, and the communication processor 220 may determine whether the housing state at the current time point is the open state.

When the housing state at the current time point, which is read from the housing state buffer 224, is the open state, the method may proceed to operation S1240, and the communication processor 220 may determine the device state to be the second state.

When the housing state at the current time point, which is read from the housing state buffer 224, is not the open state but the folded state, the method may proceed to operation S1250, and the communication processor 220 may determine the device state to be the third state.

Referring again to FIG. 11, in operation S1120, the communication processor 220 may calculate the window TER value at the consumption time point based on the device state. When the device state is the first state, the communication processor 220 may calculate the window TER value at the consumption time point by using Equation 2. When the device state is the second state, the communication processor 220 may calculate the window TER value at the consumption time point by using Equation 3. When the device state is the third state, the communication processor 220 may calculate the window TER value at the consumption time point by using Equation 4.

In operation S1130, the communication processor 220 may calculate a consumed TER value based on window TER values. The communication processor 220 may calculate the consumed TER value by using Equations 5 to 8.

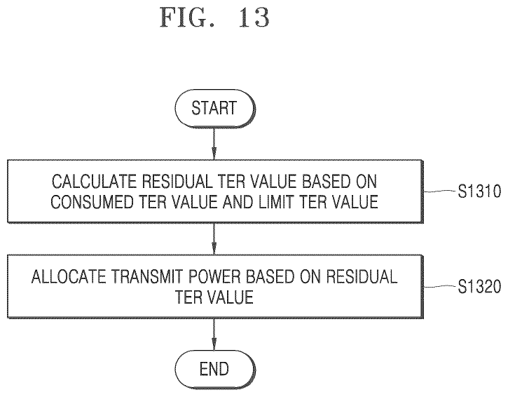

Referring again to FIG. 10, in operation S1020, the electronic device 200 may allocate transmit power via the communication processor 220, based on the consumed TER value. A more detailed method of allocating the transmit power based on the consumed TER value may be same as shown in FIG. 13.

FIG. 13 is a flowchart illustrating a method of allocating transmit power of an electronic device, according to some example embodiments.

Referring to FIG. 13, in operation S1310, the communication processor 220 may calculate a residual TER value based on the consumed TER value and a limit TER value. The communication processor 220 may calculate the residual TER value by subtracting the consumed TER value from the limit TER value.

In operation S1320, the communication processor 220 may allocate the transmit power based on the residual TER value. The communication processor 220 may calculate an available TER value based on the residual TER value and may calculate a transmit power limit of a used-antenna based on the available TER value. The communication processor 220 may allocate the transmit power to one or more transmit antennas based on the transmit power limit.

As described above, use of the method of operating the electronic device 200, according to the inventive concepts, may allow optimum or desired communication performance to be provided while the TER value regulation condition is satisfied, by allocating transmit power to one or more transmit antennas from among a plurality of antennas based on the housing state between the first housing 201 and the second housing 202.

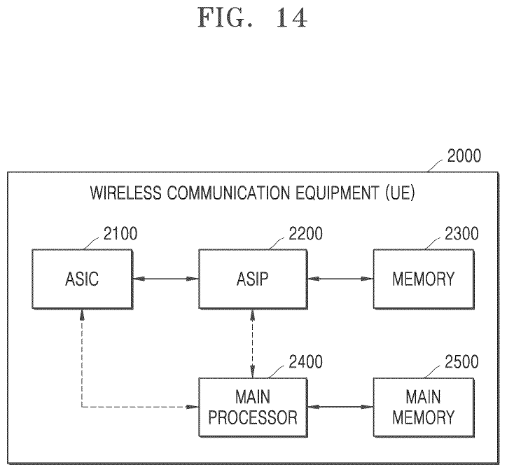

FIG. 14 is a block diagram illustrating user equipment according to some example embodiments.

Referring to FIG. 14, wireless communication equipment (which may be referred to as user equipment) 2000 may include an application-specific integrated circuit (ASIC) 2100, an application-specific instruction-set processor (ASIP) 2200, a memory 2300, a main processor 2400, and a main memory 2500. Two or more of the ASIC 2100, the ASIP 2200, and the main processor 2400 may communicate with each other. In addition, at least two of the ASIC 2100, the ASIP 2200, the memory 2300, the main processor 2400, and the main memory 2500 may be embedded in a single chip.

The ASIC 2100 is an integrated circuit customized for a particular use and may include, for example, an RFIC, a modulator, a demodulator, or the like. The ASIP 2200 may support a dedicated instruction set for a particular application and may execute instructions that are included in the instruction set. The memory 2300 may communicate with the ASIP 2200 and, as a non-transitory storage device, may store a plurality of instructions executed by the ASIP 2200. For example, the memory 2300 may include any type of memory capable of being accessed by the ASIP 2200, such as random access memory (RAM), read-only memory (ROM), tape, a magnetic disk, an optical disk, volatile memory, nonvolatile memory, and a combination thereof.

The main processor 2400 may control the user equipment 2000 by executing a plurality of instructions. For example, the main processor 2400 may control the ASIC 2100 and the ASIP 2200 and may process data received via a wireless communication network or process a user input to the user equipment 2000. The main memory 2500 may communicate with the main processor 2400 and, as a non-transitory storage device, may store a plurality of instructions executed by the main processor 2400. For example, the main memory 2500 may include any type of memory capable of being accessed by the main processor 2400, such as RAM, ROM, tape, a magnetic disk, an optical disk, volatile memory, nonvolatile memory, and a combination thereof.

The aforementioned components of the electronic device 200 or the aforementioned operations constituting the operation method of the electronic device 200, according to some example embodiments, may be included in at least one of the components of the wireless communication equipment 2000 of FIG. 14. For example, the electronic device 200 of FIG. 1 or at least one of the aforementioned operations of the operation method of the electronic device 200 may be implemented as a plurality of instructions stored in the memory 2300, and the ASIP 2200 may perform an operation of the electronic device 200 or the at least one operation of the operation method by executing the plurality of instructions stored in the memory 2300. As another example, the electronic device 200 of FIG. 1 or at least one of the aforementioned operations of the operation method of the electronic device 200 may be implemented as a hardware block and included in the ASIC 2100. As another example, the electronic device 200 of FIG. 1 or at least one of the aforementioned operations of the operation method of the electronic device 200 may be implemented by a plurality of instructions stored in the main memory 2500, and the main processor 2400 may perform an operation of the electronic device 200 or the at least one operation of the operation method of the electronic device 200 by executing the plurality of instructions stored in the main memory 2500.

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

While the inventive concepts have been particularly shown and described with reference to some example embodiments thereof, it will be understood that various changes in form and details may be made therein without departing from the spirit and scope of the following claims.

1. An electronic device comprising:
a first housing;
a second housing connected to the first housing;
a transmitter comprising a plurality of antennas, the transmitter configured to control the plurality of antennas to transmit signals, the plurality of antennas being respectively in the first housing or the second housing; and
a communication processor configured to allocate transmit power of each of the plurality of antennas,
the communication processor comprising a controller configured to:
calculate a consumed total exposure ratio (TER) value of each of the plurality of antennas based on a housing state between the first housing and the second housing; and
allocate transmit power to one or more transmit antennas from among the plurality of antennas based on the consumed TER value.

2. The electronic device of claim 1, wherein the controller is further configured to:
determine a device state based on the housing state at a consumption time point and the housing state at a current time point;
calculate a window TER value at the consumption time point based on the device state; and
calculate the consumed TER value based on window TER values at time points that are included in a TER measurement interval.

3. The electronic device of claim 2, wherein the controller is further configured to:
determine the device state to be a first state, based on the housing state at the consumption time point being a folded state;
determine the device state to be a second state, based on the housing state at the consumption time point being an open state and the housing state at the current time point being the open state; and
determine the device state to be a third state, based on the housing state at the consumption time point being the open state and the housing state at the current time point being the folded state.

4. The electronic device of claim 3, wherein the controller is further configured to, based on the device state being the first state, calculate the window TER value at the consumption time point by adding up respective TER values of the plurality of antennas at the consumption time point.

5. The electronic device of claim 3, wherein the controller is further configured to, based on the device state being the second state, calculate the window TER value at the consumption time point based on respective TER values of the plurality of antennas at the consumption time point and a correlation coefficient between the plurality of antennas.

6. The electronic device of claim 3, wherein the controller is further configured to, based on the device state being the third state, calculate the window TER value at the consumption time point by selecting a maximum value from among a window TER value based on the device state being the second state and respective TER values of the plurality of antennas at the consumption time point.

7. The electronic device of claim 1, wherein the controller is further configured to:
calculate a residual TER value based on the consumed TER value and a limit TER value; and
allocate the transmit power to the one or more transmit antennas, based on the residual TER value.

8. The electronic device of claim 1, wherein the communication processor further comprises a memory comprising:
an antenna index buffer storing a used-antenna index indicating one or more used-antennas that are used in each window; and
a used-power buffer storing used power of an antenna that corresponds to the used-antenna index.

9. The electronic device of claim 8, wherein the controller is further configured to:
read the used-antenna index from the antenna index buffer;
read, from the used-power buffer, the used power of the antenna corresponding to the used-antenna index; and
calculate a window TER value based on the used-antenna index and the used power.

10. The electronic device of claim 8, wherein the memory further comprises a housing state buffer storing the housing state at a time point corresponding to each window.

11. The electronic device of claim 10, wherein the controller is further configured to:
read the housing state at a consumption time point from the housing state buffer;
read the housing state at a current time point from the housing state buffer;
determine a device state based on the housing state at the consumption time point and the housing state at the current time point;
calculate a window TER value at the consumption time point based on the device state; and
calculate the consumed TER value based on window TER values at time points that are included in a TER measurement interval.

12. An operation method of an electronic device, the electronic device comprising a first housing, a second housing connected to the first housing, a transmitter comprising a plurality of antennas respectively in the first housing or the second housing and the transmitter configured to control the plurality of antennas to transmit signals, and a communication processor configured to allocate transmit power of each of the plurality of antennas, the operation method comprising:
calculating, via the communication processor, a consumed total exposure ratio (TER) value of each of the plurality of antennas based on a housing state between the first housing and the second housing; and
allocating, via the communication processor, transmit power to one or more transmit antennas from among the plurality of antennas based on the consumed TER value.

13. The operation method of claim 12, wherein the calculating of the consumed TER value comprises:
determining a device state based on the housing state at a consumption time point and the housing state at a current time point;
calculating a window TER value at the consumption time point based on the device state; and
calculating the consumed TER value based on window TER values at time points that are included in a TER measurement interval.

14. The operation method of claim 13, wherein the determining of the device state comprises:
determining the device state to be a first state, based on the housing state at the consumption time point being a folded state;
determining the device state to be a second state, based on the housing state at the consumption time point being an open state and the housing state at the current time point being the open state; and
determining the device state to be a third state, based on the housing state at the consumption time point being the open state and the housing state at the current time point being the folded state.

15. The operation method of claim 14, wherein the calculating of the window TER value at the consumption time point comprises, based on the device state being the first state, calculating the window TER value at the consumption time point by adding up respective TER values of the plurality of antennas at the consumption time point.

16. The operation method of claim 14, wherein the calculating of the window TER value at the consumption time point comprises, based on the device state being the second state, calculating the window TER value at the consumption time point based on respective TER values of the plurality of antennas at the consumption time point and a correlation coefficient between the plurality of antennas.

17. The operation method of claim 14, wherein the calculating of the window TER value at the consumption time point comprises, based on the device state being the third state, calculating the window TER value at the consumption time point by selecting a maximum value from among a window TER value based on the device state being the second state and respective TER values of the plurality of antennas at the consumption time point.

18. The operation method of claim 12, wherein the allocating of the transmit power comprises:
calculating a residual TER value based on the consumed TER value and a limit TER value; and
allocating the transmit power to the one or more transmit antennas, based on the residual TER value.

19. An electronic device comprising:
a first housing;
a second housing connected to the first housing;
a transmitter comprising a plurality of antennas and the transmitter configured to control the plurality of antennas to transmit signals, the plurality of antennas being respectively in the first housing or the second housing; and
a communication processor configured to allocate transmit power of each of the plurality of antennas,
the communication processor comprising a controller configured to:
determine a device state based on a housing state between the first housing and the second housing at a consumption time point and at a current time point;
calculate a consumed total exposure ratio (TER) value of each of the plurality of antennas based on the device state; and
allocate transmit power to one or more transmit antennas from among the plurality of antennas based on the consumed TER value.

20. The electronic device of claim 19, wherein the controller is further configured to:
determine the device state to be a first state, based on the housing state at the consumption time point being a folded state;
determine the device state to be a second state, based on the housing state at the consumption time point being an open state and the housing state at the current time point being the open state; and
determine the device state to be a third state, based on the housing state at the consumption time point being the open state and the housing state at the current time point being the folded state.

21. (canceled)

22. (canceled)

23. (canceled)

24. (canceled)

25. (canceled)
